(19) United States
(12) Patent Application Publication
(10) Pub. No.: US 2023/0139092 A1
(43) Pub. Date: May 4, 2023

(54) APPARATUS FOR OPERATING AN ADJUSTMENT DEVICE OF A SEAT, SEAT, IN PARTICULAR VEHICLE SEAT, AND VEHICLE

(71) Applicant: Adient US LLC, Plymouth, MI (US)

(72) Inventors: Ingo QUAST, Duesseldorf (DE); Erik SPRENGER, Wermelskirchen (DE); Kornel ZALAVARI, Solingen (DE)

(21) Appl. No.: 18/048,897

(22) Filed: Oct. 24, 2022

(30) Foreign Application Priority Data
Oct. 29, 2021 (DE) 10 2021 212 269.8
Mar. 15, 2022 (DE) 10 2022 202 549.0

(51) Int. Cl. B60N 2/427; H02J 9/00; H02J 7/34; H02J 7/00

(52) U.S. Cl. CPC B60N 2/4279; H02J 9/00; H02J 7/345; H02J 7/00712; H02J 7/0063; H02J 7/0048

(57) ABSTRACT

An apparatus for operating a longitudinal seat adjustment device of a vehicle seat may have one drive unit for the adjustment device, a control unit for controlling the at least one drive unit, a main power supply unit for providing a main supply voltage during normal operation and a rechargeable, emergency power supply unit which is configured to provide during emergency operation an emergency supply voltage for the control unit and the drive unit. A vehicle having such an apparatus for operating the adjustment device is also provided.

### FIELD

The invention relates to an apparatus for operating an adjustment device, in particular a longitudinal seat adjustment device, of a seat, in particular a vehicle seat. The invention further relates to a seat and a vehicle having such an apparatus.

### BACKGROUND

Adjustment devices, for example, a longitudinal seat adjustment device or a backrest inclination adjustment device, for a vehicle seat are known from the prior art. The longitudinal seat adjustment device generally comprises two rail pairs which are arranged with spacing from each other. In this case, the respective rail pair has a lower rail which is arranged so as to be fixed to the vehicle and an upper rail which is partially guided therein relative to the lower ail. Furthermore, the longitudinal seat adjustment device has a number of drive units and gear mechanism units and a control unit for controlling the longitudinal seat adjustment device. A synchronisation of a seat rail position and displacement speed is carried out via the control unit which is coupled to the drive unit with corresponding software and signal evaluation from the drive unit. The control unit and the drive unit are supplied with energy via an on-board network on the vehicle.

### SUMMARY

An object of the present invention is to provide an improved apparatus for operating an adjustment device of a seat, in particular of a vehicle seat, a seat and a vehicle having such an improved apparatus.

The object is achieved according to the invention by an apparatus for operating an adjustment device of a seat, a seat, in particular a vehicle seat, and the vehicle as described and claimed herein.

The dependent patent claims relate to advantageous developments.

The apparatus according to the invention for operating an adjustment device, in particular a longitudinal seat adjustment device, of a seat, in particular a vehicle seat, for a vehicle comprises at least one drive unit for the adjustment device, a control unit for controlling the at least one drive unit, a main power supply unit for providing a main supply voltage during normal operation and a, particularly rechargeable, emergency power supply unit which is configured to provide during emergency operation an emergency supply voltage for operating the drive unit and the control unit.

For example, the main power supply unit is an on-board network and/or a main battery of the vehicle. The emergency power supply unit is particularly a rechargeable emergency battery and/or a rechargeable supercapacitor.

The control unit is or can be electrically connected to the main power supply unit, in particular the on-board network or the main battery of the vehicle, in order to control the at least one drive unit during normal operation. The emergency power supply unit is a separate energy storage unit. The emergency power supply unit is electrically disconnected from the main power supply unit. The control unit is or can be electrically connected to the emergency power supply unit, in particular an emergency battery or a supercapacitor, in order to control the at least one drive unit during emergency operation.

The emergency power supply unit is configured to provide the emergency supply voltage for the control unit and the at least one drive unit during emergency operation, particularly in the event of detection of an emergency situation of the vehicle and/or in the event of failure of the main power supply unit and/or if a value falls below a limit value for the main supply voltage, in particular to supply electrical energy to the control unit and the at least one drive unit.

The adjustment unit may be in particular a longitudinal seat adjustment device, a seat height adjustment device and/or a backrest inclination adjustment device of the vehicle seat.

An apparatus constructed in this manner, in particular for operating an adjustment device, ensures that the control unit and the at least one drive unit can be supplied with electrical energy from the emergency power supply unit in the event of an emergency situation being detected, for example, in the event of a collision-related failure of the main power supply unit, such as, for example, the on-board network. By the electrical energy which is made available by the emergency power supply unit, the vehicle seat or components of the vehicle seat can also be adjusted, in particular displaced and/or pivoted, into a predetermined emergency position, in particular an exit position, a so-called emergency exit position, when the main power supply unit fails. Consequently, it is possible for occupants who are sitting behind the vehicle seat to be able to leave the vehicle in an unimpeded manner and as quickly as possible. Therefore, the vehicle can be comparatively promptly left by the occupants so that the occupants, particularly if the vehicle is involved in an accident, can save themselves.

The seat, in particular the vehicle seat, is particularly an electrically adjustable seat having an electrically operable adjustment device. In this case, a corresponding control of the at least one drive unit can be achieved via the control unit in order to operate the adjustment device, such as, for example, the longitudinal seat adjustment device and/or seat height adjustment device and/or backrest inclination adjustment device, wherein in particular great adjustment paths and/or pivot paths with variable positions for particularly different seat rail positions and/or backrest positions can be achieved by the adjustment device.

In particular, during emergency operation, such as, for example, after an accident of the vehicle if the main power supply unit fails, the apparatus allows a longitudinal adjustment and/or a height adjustment and/or a backrest inclination adjustment of the vehicle seat. As a result of an accident, the main current supply of the adjustment device can be interrupted via the on-board network, in particular by the failure thereof. The emergency power supply unit which is electrically disconnected from the main power supply unit, for example, the on-board network, ensures that the electrically adjustable vehicle seat can be adjusted into a predetermined emergency position, in particular moved or displaced into the predetermined exit position, during emergency operation.

The emergency supply voltage is particularly preferably in the form of a direct-current voltage. The value of the emergency supply voltage may be equal to or less than the value of the main supply voltage.

The control unit is, for example, a component of a so-called control box, a control device or a control apparatus of the apparatus for operating the adjustment device of the vehicle seat.

In particular, the emergency power supply unit is integrated in a housing of the apparatus in a development. The apparatus may partially be in the form of a separate assembly module, wherein at least the emergency power supply unit and control unit are arranged in the housing, in particular encapsulated in a protected manner.

The emergency power supply unit or separate energy storage unit continues to supply electrical emergency supply energy, in particular emergency supply voltage and emergency supply current, to the control unit and the at least one drive unit, particularly in the form of an electric motor, for example, if the main power supply unit fails, for example, an on-board network, particularly after an accident of the vehicle. To this end, the emergency power supply unit may be in the form of a supercapacitor. Such a supercapacitor, for example, in the form of a double-layer capacitor, can be charged and also discharged comparatively quickly. The supercapacitor in the form of an emergency power supply unit or separate energy storage unit is, if necessary, in particular in a detected emergency situation, configured or laid out for one-off adjustment of the vehicle seat into a predetermined position, in particular an emergency position. For example, the vehicle seat can be adjusted, in particular longitudinally adjusted, vertically adjusted and/or inclined, by the emergency supply voltage which is made available in a one-off manner in the longitudinal direction, vertical direction and/or in terms of backrest inclination.

Alternatively or additionally, another suitable emergency power supply unit or energy storage unit which has a corresponding service-life can also be used in order to act in a detected emergency situation of the vehicle as a potential energy supplier in order to position the vehicle seat in the predetermined emergency position, in particular an exit position, to adjust the height and/or to adjust the backrest inclination.

In one embodiment, the control unit of the adjustment device, in particular the longitudinal seat adjustment device, is constructed to continuously detect and/or to check a charging state of the emergency power supply unit. By the charging state being continuously detected and checked, it can be ensured that the emergency power supply unit is operable during emergency operation and provides the emergency supply voltage. To this end, for example, the control unit comprises a corresponding battery management application. For example, the charging state of the emergency power supply unit can be derived from a voltage measurement, a current measurement and a temperature measurement of the emergency power supply unit.

A development of the apparatus makes provision for the control unit to be constructed to charge the emergency power supply unit if a value falls below a predetermined, in particular minimum, charging state via the main power supply unit, for example, via the on-board network of the vehicle. In this case, such a minimum charging state at which during emergency operation the positioning of the vehicle seat in the predetermined emergency position, in particular an emergency exit position, can be reliably adjusted is predetermined. That is to say, in other words, that, when the predetermined minimum charging state is reached, the emergency power supply unit is automatically charged to a value greater than the minimum charging state so that during emergency operation so much electrical energy can always be made available by the emergency power supply unit that the vehicle seat can be longitudinally adjusted in particular into the predetermined exit position, that is to say, the emergency exit position.

According to a development, the control unit is constructed to identify emergency operation if an emergency situation of the vehicle is detected and/or a failure of the main supply voltage is detected and/or it is detected that a value falls below a threshold value for the main supply voltage and to generate a control signal, when emergency operation is identified, to apply the emergency supply voltage of the emergency power supply unit to the adjustment device.

For example, the emergency power supply unit is configured to provide the emergency supply voltage, in particular to supply electrical energy to the control unit and the at least one drive unit, during emergency operation, in particular if an emergency situation of the vehicle is detected and identified and/or if a failure of the main supply voltage is detected and identified and/or if a value falling below a threshold value for the main supply voltage is detected and identified. For example, the adjustment device is configured to automatically adjust, during emergency operation, at least one component of the vehicle seat by electrical energy of the emergency power supply unit and control, in particular emergency control of the control unit, into the predetermined emergency position, in particular to adjust it into an emergency exit position, for example, to adjust a seat position of the vehicle seat in the longitudinal direction.

Since, in a possible embodiment of the apparatus, the emergency power supply unit is integrated in the housing, line paths, particularly in order to electrically connect the emergency power supply unit to the control unit and the at least one drive unit, are comparatively short. A set of lines between the emergency power supply unit and the control unit and the at least one drive unit is also arranged with protection from mechanical damage in the housing of the control unit. In particular, the apparatus arranged in the housing does not constitute an obstacle for occupants who are getting in or out of the vehicle.

Alternatively, the emergency power supply unit can also be arranged at a different suitable position of the adjustment device, in particular the longitudinal seat adjustment device, and electrically connected to the control unit and the at least one drive unit.

The adjustment device which is in the form, for example, of a longitudinal seat adjustment device comprises a rail arrangement having two seat rails, in particular rail pairs. Each of the two rail pairs has a lower rail and an upper rail. The vehicle seat is fixed to the upper rail and thereby displaceably supported relative to the lower rail. In order to adjust, in particular longitudinally adjust, the vehicle seat, the seat rails, in particular the upper rails, are synchronised with each other. The synchronisation is carried out via the control unit of the longitudinal seat adjustment device. For example, the drive unit is connected to the two upper rails, if the upper rails are connected to a common drive unit, in such a manner that the upper rails are synchronously adjusted when the common drive unit is controlled. Alternatively, each of the seat rails, in particular each upper rail, is connected to an individual electromotive drive unit. In this embodiment, the plurality of drive units are synchronously controlled and driven by the control unit.

The control unit is connected, for example, to the drive unit or the drive units in technical signal terms and/or technical electric current supply terms. The longitudinal seat adjustment device is provided for the electrical longitudinal adjustment of the vehicle seat. For example, the vehicle seat can be positioned in the vehicle by the longitudinal seat adjustment device in such a manner that, for example, greater freedom for the legs can be made available for an occupant on the vehicle seat or also an occupant sitting behind the vehicle seat.

In another possible embodiment, the control unit is constructed to detect at least one failure of the on-board network as an emergency situation. For example, it is possible for a sudden voltage decrease to be detected by the control unit. Alternatively or additionally, a collision of the vehicle is identified as a result of detected signals of a collision sensor system. In accordance with a detected collision severity, an emergency situation is identified and an emergency operation is activated. During emergency operation, for example, it is possible to cause the on-board network to be automatically switched off and the emergency power supply unit to be electrically connected automatically to the control unit and the adjustment device. In this instance, the emergency power supply unit in this emergency operation makes available the electrical energy which is necessary to position the vehicle seat in the emergency position, in particular an exit position. In particular, such emergency supply voltage which at least corresponds to the electrical energy of the control unit in order to control the at least one drive unit and the at least one electrical drive unit is provided.

In one embodiment, the adjustment device, in particular the longitudinal seat adjustment device, is constructed automatically to displace the vehicle seat by electrical energy of the emergency power supply unit in the event of detection of an emergency situation into a predetermined seat position relative to the lower seat rail. The predetermined seat position is a predetermined exit position, in particular an emergency exit position of the vehicle seat. It thereby becomes possible for the occupant who is sitting behind the vehicle seat to get out of the vehicle in an unimpeded manner as far as possible.

The invention further relates to a vehicle having a seat, in particular a vehicle seat, having at least one adjustment device described above and having the above-described apparatus for operating the adjustment apparatus, in particular a longitudinal seat adjustment device.

The adjustment device is, for example, a longitudinal seat adjustment device which comprises, for example, at least one rail arrangement having two seat rails which can be moved relative to each other.

The apparatus comprises the at least one drive unit for carrying out an adjustment of the adjustment device, in particular for adjusting one of the seat rails relative to the other seat rail, the control unit which is or can be electrically connected to the main power supply unit in order to control the at least one drive unit, and the emergency power supply unit which is electrically disconnected from the main power supply unit of the vehicle and which supplies electrical energy to the control unit and the at least one drive unit in the event of detection of an emergency situation of the vehicle. In this case, the term “emergency situation” is intended to be understood in particular to be a failure of the on-board network or an emergency shutdown of the on-board network, for example, as a result of a collision of the vehicle, and/or a value falling below a threshold value for the main supply voltage.

The emergency power supply unit or energy storage unit can ensure to the greatest possible extent that in one of the emergency situations, for example, in the event of a failure of the on-board network, the control unit and the at least one electrical drive unit are supplied with electrical energy so that the vehicle seat can be adjusted, for example, longitudinally adjusted, into the predetermined emergency position, in particular an emergency exit position.

### DESCRIPTION OF THE FIGURES

Embodiments of the invention are explained in greater detail with reference to drawings, in which:

FIG. 1 schematically shows a seat, in particular a vehicle seat, having a longitudinal seat adjustment device and an apparatus for operating the longitudinal seat adjustment device,

FIG. 2 schematically shows the seat according to FIG. 1 with the apparatus for operating the longitudinal seat adjustment device in an emergency situation.

### DETAILED DESCRIPTION

Mutually corresponding components are referred to in all the Figures with the same reference numerals.

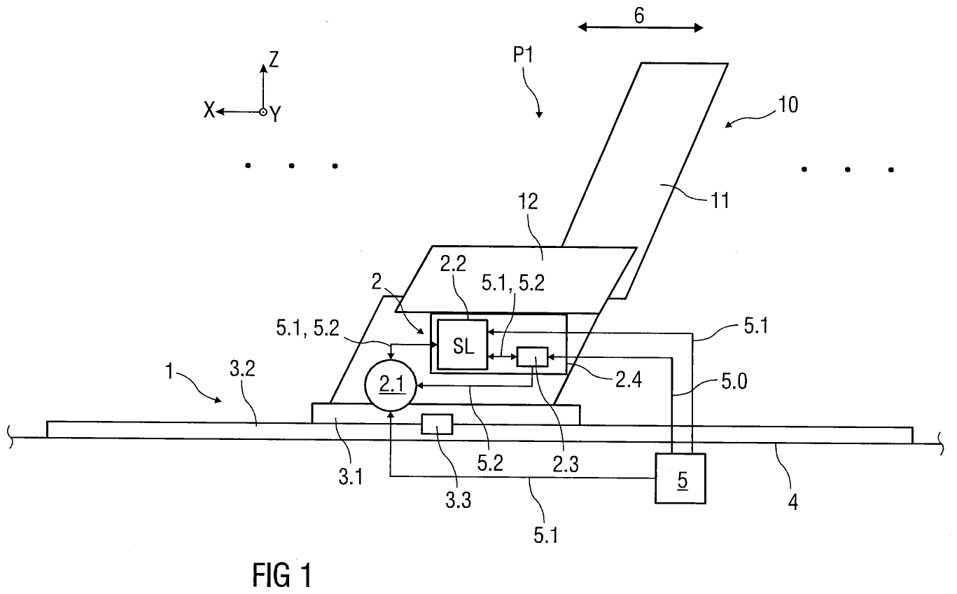

FIG. 1 schematically shows a seat 10, in particular a vehicle seat, having an adjustment device 1 and an apparatus 2 for operating the adjustment device 1, in particular for the emergency operation thereof. A vehicle which is not illustrated in greater detail may comprise one or more seats 10 as an individual seat or a bench type seat.

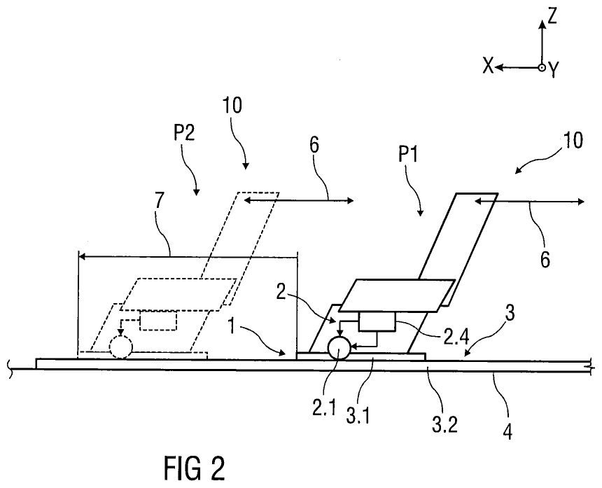

The seat 10 which is illustrated by way of example and in a highly simplified manner in FIGS. 1 and 2 is described below using spatial directions which extend perpendicularly to each other. A longitudinal direction X extends substantially horizontally in a seat 10 which is fitted in the vehicle and preferably parallel with a longitudinal vehicle direction which corresponds to the usual travel direction of the vehicle. A transverse direction Y which extends perpendicularly to the longitudinal direction X is also orientated horizontally in the vehicle and extends parallel with a transverse vehicle direction. A vertical direction Z extends perpendicularly to the longitudinal direction X and perpendicularly to the transverse direction Y. In a seat 10 which is fitted in the vehicle, the vertical direction Z extends parallel with a vertical vehicle axis.

The position indications and direction indications used, such as, for example, front, back, top and bottom, relate to a viewing direction of an occupant who is sitting on the seat 10 in a normal seat position, wherein the seat 10 is fitted in the vehicle, in a position for use which is suitable for conveying persons, with an upright backrest and is orientated as conventional in the travel direction. However, the seat 10 can also be fitted or moved in a different orientation, for example, transversely relative to the travel direction.

The seat 10 is electrically adjustable, in particular pivotable in a longitudinal direction X, in a vertical direction Z and/or in portions in a longitudinal direction X.

According to the present embodiment, the adjustment direction 1 is in the form of a longitudinal seat adjustment device and is referred to below as a longitudinal seat adjustment device 1. Alternatively or additionally, the adjustment device may be a seat height adjustment device and/or backrest inclination adjustment device. For example, a backrest 11 can be arranged pivotably on a seat member 12 of the seat 10. To this end, the seat 10 can comprise a fitting, in particular a rotary fitting, such as, for example, a lock fitting or wobble fitting.

The apparatus 2 according to the invention for operating the longitudinal seat adjustment device 1 comprises at least one drive unit 2.1 for the longitudinal seat adjustment device 1, a control unit 2.2 for controlling the at least one drive unit 2.1, a main power supply unit 5 for providing a main supply voltage during normal operation and an emergency supply unit 2.3, which is in particular rechargeable and which is configured to provide during emergency operation an emergency supply voltage for the control unit 2.2 and the drive unit 2.1.

For example, the main power supply unit 5 is an on-board network having a main battery or a main battery of the vehicle. The emergency power supply unit 2.3 is in particular a rechargeable emergency battery and/or a rechargeable supercapacitor.

The control unit 2.2 is or can be electrically connected to the main power supply unit 5, in particular the on-board network or the main battery of the vehicle, in order to control the at least one drive unit 2.1 during normal operation. The emergency power supply unit 2.3 is a separate energy storage unit. The emergency power supply unit 2.3 is electrically disconnected from the main power supply unit 5. The control unit 2.2 is or can be electrically connected to the emergency power supply unit 2.3, in particular an emergency battery or a supercapacitor, in order to control the at least one drive unit 2.1 during emergency operation.

FIG. 1 illustrates the seat 10 with the apparatus 2 in a normal position.

FIG. 2 illustrates the seat 10 with the apparatus 2 according to FIG. 1 both in a normal position, for example, the comfort position P1, and in an exit position P2 (illustrated with broken lines), in particular in an emergency exit position which is adjusted in the longitudinal direction X.

The longitudinal seat adjustment device 1 comprises, for example, a rail system having a rail pair 3 or two rail pairs 3 for long displacement paths so that the seat 10 can be positioned along the rail pair 3 or the rail pairs 3, in particular in a longitudinally adjustable manner. The seat 10 is arranged on a vehicle body 4 by the longitudinal seat adjustment device 1.

The longitudinal seat adjustment device 1 has for the seat 10, for example, two rail pairs 3 which are arranged parallel with each other. The respective rail pair 3 comprises an upper rail 3.1, also referred to as the rail runner or seat rail, and a lower rail 3.2, also referred to as the guide rail or base rail. In the embodiment, the lower rail 3.2 is constructed to be comparatively long. In a possible embodiment, the lower rail 3.2 is in the form of a common lower rail 3.2 for two longitudinal seat adjustment devices 1 of two seats 10 each having an associated short upper rail 3.1. The respective upper rail 3.1 can be adjusted relative to the lower rail 3.2 in a longitudinal direction X. The upper rail 3.1 is fixed to the seat member 12. The lower rail 3.2 is fixed to a structural element of the vehicle, for example, a vehicle base or the vehicle body 4.

The upper rail 3.1 is arranged on the lower rail 3.2 so as to be longitudinally adjustable between a front end position and a rear end position. This adjustability allows a longitudinal adjustment of the position of the seat 10 in a longitudinal direction X. Particularly during normal operation or normal use (Comfort Adjustment), the seat 10 can be positioned in a longitudinally adjustable manner by the longitudinal seat adjustment device 1 in a region which is ideal and desired for an occupant on the seat 10, for example, in and counter to a travel direction, that is to say, in the longitudinal direction X, in particular along the lower rail 3.2.

The longitudinal seat adjustment device 1 further comprises at least one locking element which is not illustrated in greater detail. In this case, each rail pair 3 may comprise an associated locking element 3.3. A movement of the upper rail 3.1 in the lower rail 3.2 is blocked by the locking element 3.3. For example, the locking element 3.3 is in the form of a locking plate or pivot plate.

The respective seat 10 is releasably fixed to the associated rail pair 3, in particular to the upper rail 3.1, by suitable fixing elements which are not illustrated in greater detail, in particular locking hooks or claws.

The apparatus 2 which is associated with the respective seat 10 has at least the one drive unit 2.1 for the adjustment device 1, in particular for the longitudinal seat adjustment device 1, the control unit 2.2, which is or can be electrically connected to the main power supply unit 5 of the vehicle, in order to control the at least one drive unit 2.1, and the energy storage unit or emergency power supply unit 2.3 which is electrically disconnected from the main power supply unit 5 of the vehicle and which, in the event of detection of an emergency situation of the vehicle, supplies the control unit 2.2 and the at least one drive unit 2.1 with electrical energy.

According to the present embodiment, the apparatus 2 has one drive unit 2.1, in particular an electromotive drive unit, for operating the longitudinal seat adjustment device 1 per rail pair 3, for example, in the form of an electrical servomotor, and a gear mechanism unit which is connected to the drive unit 2.1 and which is not illustrated in greater detail for connection to the movable upper rail 3.1. The seat 10 is displaceably supported by the drive units 2.1 and the gear mechanism units along the lower rail 3.2 which is associated with the seat 10. For example, the longitudinal seat adjustment device 1 comprises a spindle arrangement for longitudinally adjusting the seat 10. The number of drive units 2.1 and/or the gear mechanism units can vary in accordance with an embodiment of the seat 10 and/or the longitudinal seat adjustment device 1.

In a possible embodiment, the drive units 2.1, the control unit 2.2 and/or the emergency power supply unit 2.3 can be in the form of a compact assembly module which can be fixed to the seat 10, in particular to a lower side of the seat 10. In this case, at least the control unit 2.2 and the emergency power supply unit 2.3 can be arranged in a housing 2.4.

A longitudinal adjustment path 6, in particular in the longitudinal direction X, for longitudinally adjusting the seat 10 into one or more comfort positions P1 is indicated by an arrow.

An emergency longitudinal adjustment path 7, in particular in the longitudinal direction X, for longitudinally adjusting the seat 10 into a predetermined exit position P2, in particular an emergency exit position, which is illustrated by a broken line is indicated by an arrow. In this case, the exit position P2 denotes a position of the seat 10, in which occupants who are sitting behind the seat 10 can get out of the vehicle in an unimpeded manner.

The apparatus 2 further has a control unit 2.2 which is shown in FIG. 1 and which is connected to the drive units 2.1 of the rail pairs 3 in particular in technical signal terms and technical current supply terms. The drive units 2.1 can be controlled by the control unit 2.2 so that the seat 10 can be electrically adjusted in the direction of the longitudinal adjustment paths 6, 7 into a respective desired comfort position P1 and into the exit position P2.

The seat 10 is particularly electrically adjustable, wherein comparatively great adjustment paths with more precise seat rail positions and at high adjustment speeds can be achieved via the control unit 2.2.

Adjustments of the upper rails 3.1 of the respective seat 10 are intended to be synchronised with each other in order to longitudinally adjust the seat 10. This synchronisation is carried out via the control unit 2.2. In particular, the drive units 2.1 are controlled by the control unit 2.2 for the synchronisation.

Electric current is supplied to the drive units 2.1 and the control unit 2.2 via a vehicle current supply, in particular the main power supply unit 5, as shown in FIG. 1. In particular, electrical energy is supplied centrally via the main power supply unit 5 to the control unit 2.2.

The electric current can be supplied to the drive units 2.1 during normal operation, for example, directly via a respective current line 5.1 by the main power supply unit 5 and/or the control unit 2.2. To this end, the respective current line 5.1 electrically connects the drive units 2.1 to the main power supply unit 5 and/or to the control unit 2.2.

Furthermore, the current line 5.1 between the respective drive unit 2.1 and the control unit 2.2 can comprise, in addition to a power supply line, a signal line, via which the control unit 2.2 controls the drive units 2.1. Alternatively, a combined current line and signal line may also be provided both for electrical power supply and for control between the respective drive unit 2.1 and the control unit 2.2.

In the embodiment according to FIG. 1, the drive unit 2.1 is connected during normal operation to the main power supply unit 5 via an associated current line 5.1 directly and additionally indirectly via the control unit 2.2.

For emergency operation, the drive unit 2.1 and the control unit 2.2 are each connected via an associated emergency current line 5.2 directly to the emergency power supply unit 2.3.

FIG. 2 shows the seat 10 according to FIG. 1 with the apparatus 2 for operating the longitudinal seat adjustment device 1 during emergency operation.

In order nevertheless to position the seat 10 in a predetermined exit position P2, the emergency exit position, during emergency operation of the vehicle, for example, in the event of a failure of the main power supply unit 5, for example, as a result of a collision of the vehicle, the apparatus 2 is constructed as described below.

After an accident and/or a failure of the vehicle current supply, that is to say, the main power supply unit 5, the seat 10 is intended to be displaced into the predetermined exit position P2, in particular into the emergency exit position, in order to allow occupants of seating positions behind the seat 10 to leave so that they can save themselves, in particular in the event of a collision of the vehicle.

To this end, the apparatus 2 has the electric current source which is electrically disconnected from the main power supply unit 5 at the vehicle side in the form of the emergency power supply unit 2.3. In this case, the emergency power supply unit 2.3 and the control unit 2.2 can be arranged in the housing 2.4 of the apparatus 2, in a so-called control box. These portions, arranged in the housing 2.4, of the apparatus 2 may be in the form of an assembly module of the apparatus 2. The emergency power supply unit 2.3 can also be integrated in the control unit 2.2.

The drive units 2.1 and the control unit 2.2 each comprise a separate electrical connection with respect to the emergency power supply unit 2.3 via the emergency current line 5.2, in particular an individual, integrated emergency power supply unit 2.3 which in the event of detection of an emergency situation supplies electrical energy to the drive units 2.1 and the control unit 2.2.

As described above, electrical energy is supplied centrally to the control unit 2.2 via the main power supply unit 5. The control unit 2.2 is used for control and synchronisation of the drive units 2.1. To this end, a corresponding control logic SL is implemented in the control unit 2.2.

The emergency power supply unit 2.3 is permanently charged, wherein a charging state is detected and monitored by the control unit 2.2. A current supply of the drive units 2.1 and the control unit 2.2 for minimum functions, at least for safety functions, can be ensured during emergency operation, in particular after an accident and/or after a failure of the main power supply unit 5, by the electrical energy which is made available by the emergency power supply unit 2.3.

For example, the charging state of the emergency power supply unit 2.3 can be derived by the control unit 2.2 from a voltage measurement, a current measurement and a temperature measurement of the emergency power supply unit 2.3.

Furthermore, the control unit 2.2 can be constructed to charge the emergency power supply unit 2.3 if a value falls below a predetermined, particularly minimum, charging state via the main power supply unit 5, for example, via the on-board network of the vehicle. To this end, a charging line 5.0, in particular a switchable charging line, is provided between the emergency power supply unit 2.3 and the main power supply unit 5.

For example, there is predetermined for the emergency power supply unit 2.3 such a minimum charging state, at which during emergency operation the positioning of the vehicle seat into a predetermined emergency position, such as, for example, the exit position P2 (also referred to as the emergency exit position) can be reliably adjusted.

The control unit 2.2 is connected to the drive units 2.1 via the current line 5.1. The energy is thereby supplied during normal operation. The current line 5.1 comprises, for example, the power supply line and a signal line, that is to say, a control line. Alternatively, a combined power supply line and control line can be provided. This line is used both for electrical supply and for signal transmission for controlling and synchronising the drive units 2.1. The drive units 2.1 and the control unit 2.2, in particular the control logic SL, are connected to each other by the current line 5.1 in technical signal terms and technical power supply terms. Alternatively, the control logic SL of the control unit 2.2 is connected to the drive units 2.1 via at least one additional control line.

If a separate emergency current line 5.2 is not provided between the control unit 2.2 and the drive units 2.1, the current line 5.1 is then used as the emergency current line 5.2 between the control unit 2.2 and the drive units 2.1 during emergency operation by the current line 5.1 being switched off between the control unit 2.2 and the main power supply unit 5 and the emergency current line 5.2 being switched on between the emergency power supply unit 2.3 and the control unit 2.2.

Alternatively, the control unit 2.2 can be connected with the implemented control logic SL to the emergency power supply unit 2.3 via an additional, in particular separate, emergency power line 5.2. For example, the emergency current line 5.2 comprises a power supply line and a control line. Alternatively, this line is in the form of a combined power supply line and control line.

The control unit 2.2 and the emergency power supply unit 2.3 are connected to each other by the separate emergency current line 5.2 in technical signal terms and technical power supply terms. Alternatively, the control unit 2.2 is connected to the emergency power supply unit 2.3 via the separate emergency current line 5.2, in particular power supply line, electrically and via at least one additional control line in technical signal terms.

During normal use, the electric current is supplied via the main power supply unit 5. In the case of detection of an emergency situation, the electric current is supplied to the control unit 2.2, in particular the control logic SL, via the emergency power supply unit 2.3 and the separate emergency current line 5.2.

In another embodiment, the drive units 2.1 are electrically connected to the main power supply unit 5 via the current line 5.1 and additionally to the emergency power supply unit 2.3 via the emergency current line 5.2. In addition, the drive units 2.1 are connected in technical signal terms to the control unit 2.2, in particular to the control logic SL, via a control line which may be part of the current line 5.1.

The emergency power supply unit 2.3 may be in the form of a supercapacitor. A plurality of such supercapacitors can also be constructed as an emergency power supply unit 2.3 of the apparatus 2. Such supercapacitors can be charged comparatively rapidly and have a relatively high power density, if required. Alternatively or additionally, a different suitable energy supplier which has a service-life, for example, that of the vehicle and/or the vehicle seat, can also be used as the emergency power supply unit 2.3.

During normal use of the longitudinal seat adjustment device 1, a charging state of the emergency power supply unit 2.3 is permanently checked and where applicable corrected via the control logic SL. In particular, the charging state of the emergency power supply unit 2.3 is adapted, where applicable, by the unit being charged, for example, when a value falls below a minimum charging voltage and/or a minimum charging state.

The monitoring of the charging state of the emergency power supply unit 2.3 is carried out, for example, via the additional emergency current line 5.2, via which the emergency power supply unit 2.3 is connected to the control unit 2.2, or via an additional control line which is not shown. For example, such a minimum charging state, after reaching which the emergency power supply unit 2.3 is automatically charged, is predetermined. In this case, this predetermined minimum charging state is selected so that, even when this minimum charging state is reached, at least one one-off positioning of the seat 10 in the predetermined exit position P2, in particular an emergency exit position, continues to be possible.

The control unit 2.2 further comprises a logic unit for the charging management of the emergency power supply unit 2.3. The control unit 2.2 is constructed, for example, to charge the emergency power supply unit 2.3 if a value falls below a predetermined minimum charging state via the main power supply unit 5.

During emergency operation, for example, after an accident and/or a failure of the main power supply unit 5, the control unit 2.2 and the drive units 2.1 are automatically disconnected electrically from the main power supply unit 5 by the control unit 2.2 and automatically connected electrically to the emergency power supply unit 2.3. Consequently, access can be immediately afforded to the emergency power supply unit 2.3 in an emergency situation in order to displace the seat 10 (Emergency Exit Adjustment) which is fixed to the upper rails 3.1 as far as the defined exit position P2 (Emergency Exit Position), in and/or on the lower rails 3.2 which are fixed to the floor, in particular relative thereto, in particular forwards in the longitudinal direction X, in order to allow the occupant who is sitting behind to get out of the vehicle.

In particular, the control unit 2.2 is constructed to detect a failure of the main power supply unit 5 as an emergency situation. For example, it is possible to assess by a circuit and a logic unit which forms a corresponding basis whether an electric current source for supplying electric current to the control unit 2.2 and consequently also to the drive units 2.1 is available. If it is detected that no current source is available because the main power supply unit 5 has failed, electric current is supplied to the drive units 2.1 and the control unit 2.2 via the emergency power supply unit 2.3 which is electrically disconnected from the main power supply unit 5.

For example, it is also possible for a sudden voltage decrease to be detected by the control unit 2.2. Alternatively or additionally, if a collision of the vehicle is detected, in particular if a predetermined collision severity is exceeded, the main power supply unit 5, such as, for example, an on-board network, is automatically switched off. A risk of injury to occupants, for example, by vehicle components which conduct electric current, can thereby be reduced. If the main power supply unit 5 is switched off as a result of the collision severity established, the electrical energy required to position the seat 10 in the exit position P2 is immediately made available by the emergency power supply unit 2.3.

### LIST OF REFERENCE NUMERALS

1 Adjustment device/longitudinal seat adjustment device

2 Apparatus

2.1 Drive unit

2.2 Control unit

2.3 Emergency power supply unit

2.4 Housing

3 Rail pair

3.1 Upper rail

3.2 Lower rail

3.3 Locking element

4 Vehicle body

5 Main power supply unit

5.0 Charging line

5.1 Current line

5.2 Emergency current line

6 Longitudinal adjustment path

7 Emergency longitudinal adjustment path

10 Seat

11 Backrest

12 Seat member

P1 Comfort position

P2 Exit position

SL Control logic

X Longitudinal direction

Y Transverse direction

Z Vertical direction

What is claimed is:

1-10. (canceled)

11. An apparatus for operating a longitudinal seat adjustment device for a vehicle seat, comprising:
one drive unit for the adjustment device,
a control unit for controlling the at least one drive unit,
a main power supply unit for providing a main supply voltage during normal operation and
a rechargeable, emergency power supply unit which is configured to provide during emergency operation an emergency supply voltage for the control unit and the drive unit.

12. The apparatus according to claim 11, wherein the emergency power supply unit is in the form of at least one supercapacitor.

13. The apparatus according to claim 11, wherein the emergency supply voltage is less than the main supply voltage.

14. The apparatus according to claim 11, wherein the control unit is constructed to continuously detect and/or to check a charging state of the emergency power supply unit.

15. The apparatus according to claim 11, wherein the control unit is constructed to charge the emergency power supply unit if a value falls below a predetermined, minimum charging state via the main power supply unit.

16. The apparatus according to claim 11, further comprising a housing, in which at least the emergency power supply unit and the control unit are arranged.

17. The apparatus according to claim 11, wherein the control unit is constructed to identify emergency operation if an emergency situation of the vehicle is detected and/or a failure of the main supply voltage is detected and/or it is detected that a value falls below a threshold value for the main supply voltage and to generate a control signal, when emergency operation is identified, to apply the emergency supply voltage of the emergency power supply unit to the adjustment device.

18. A vehicle seat, having an apparatus according to claim 11, wherein the emergency power supply unit is configured to provide the emergency supply voltage during emergency operation, particularly in the event of detection of an emergency situation of the vehicle and/or in the event of failure of the main supply voltage and/or if a value falls below a threshold value for the main supply voltage, in particular to supply electrical energy to the control unit and the at least one drive unit.

19. The seat according to claim 18, wherein the adjustment device is configured to automatically place, during emergency operation, at least one component of the vehicle seat into a predetermined position by electrical energy of the emergency power supply unit.

20. A vehicle having at least one seat according to claim 18 and having the apparatus for operating an adjustment device of the vehicle seat.
